(19) United States
(12) Patent Application Publication
(10) Pub. No.: US 2015/0027014 A1
(43) Pub. Date: Jan. 29, 2015

(54) Systems and Methods for Bollard Cover Media Advertising

(71) Applicant: Bluemedia, Inc., Tempe, AZ (US)

(72) Inventors: Jared D Smith, Gilbert, AZ (US); William H Arons, Phoenix, AZ (US); Jack E Adams, Scottsdale, AZ (US)

(21) Appl. No.: 14/448,964

(22) Filed: Jul. 31, 2014

Related U.S. Application Data
(63) Continuation-in-part of application No. 14/010,260, filed on Aug. 26, 2013.
(60) Provisional application No. 61/692,878, filed on Aug. 24, 2012.

(51) Int. Cl. G09F 15/00; G09F 15/02

(52) U.S. Cl. CPC G09F 15/0075; G09F 15/02
USPC 40/607.03

(57) ABSTRACT

A system and method of covering a bollard with removeable advertising. The bollard cover comprises a sock that has graphics printed on it which has a retention mechanism near an open end to releaseably couple the sock to the bollard. Preferably the sock is made of a flexible, stretchable fabric and the retention mechanism is made of elastic. In a preferred embodiment, the fabric sock is longer than the bollard is tall and is made of flexible material that stretches in both directions. When the fabric sock is used in combination with a rigid sleeve over the bollard, the excess sock is caught between the sleeve and the bollard such that, as the sleeve and sock are pushed down over the bollard, the sock is tightened, presenting a smooth graphic design that looks as if it is painted on the bollard.

### CROSS REFERENCE TO RELATED APPLICATIONS

This application claims the benefit of and is a non-provisional of U.S. Provisional No. 61/692,878 filed on Aug. 24, 2012 and claims the benefit of co-pending U.S. application Ser. No. 14/010260 filed Aug. 26, 2013.

### TECHNICAL FIELD

The present disclosure relates to media distribution and advertising, and in particular to use of bollard covers in connection with the same.

### BACKGROUND

Bollards are structures used to divert vehicular or human traffic which are permanently or removably set in the ground, concrete or asphalt. Bollards 100 include short post concrete posts or steel pipes that are available in standard and decorative shapes and sizes, for example as illustrated by bollards 100 in FIG. 1A (PRIOR ART). Standard cylindrical bollards are usually approximately 4 to 11 inches in diameter and about 24 to 72 inches in height, although they may be much larger, depending on the intended use. In addition to cylindrical bollards mounted vertically in the ground, bollards may also be structured as generally U-shaped (for example, as illustrated by bollard 200 in FIG. 2A), V-shaped, or otherwise having multiple points of contact with the ground.

Bollards are placed in desired locations and for desired purposes, for example in parking lots on commercial properties to direct traffic and for collision prevention, to direct vehicles to drive-thru windows, to inform customers about ATM machines, to protect fuel pumps, to identify and protect electrical, telephone, cable, and backflow-prevention equipment, and so forth.

In order to improve the durability or visibility of bollards, bollards are sometime painted or covered with a sleeve. Post sleeves may be fabricated from suitable materials, for example ⅛″ thick High Density Polyethylene (HDPE). They are often available in solid opaque colors and stock sizes. Post sleeves fit over installed concrete post or steel pipe bollards, and primarily function to minimize maintenance costs while protecting the concrete or steel bollards from deterioration due to exterior exposure and weather conditions. Post sleeves are often secured to the concrete and steel bollards with adhesive foam tape or mechanical fasteners. In some cases a second cover is applied over the post sleeve, forming a multi-layer cover.

While post sleeves tend to protect concrete post or steel bollards and minimize maintenance costs associated with atmospheric deterioration, plastic post sleeves are limited in functionality and utilization. Being in areas having high vehicular or pedestrian traffic and near structures that need protection from potential collisions from such traffic means that post sleeves also get gouged, scratched, dented, marked, and otherwise marred from the occasional collision. It would be desirable to cover bollards with covers that are easily changeable when they are damaged.

Being in highly trafficked areas makes bollards useful for delivering advertising, messaging, and other marketing or communicative purposes. Historically advertising has been painted on the posts or attached as stickers. The difficulty with paint and stickers is that they are difficult to change and make look good, especially for lay people who have no experience doing so. It is desirable for graphics to display smoothly and accurately, without being skewed or misplaced, or with wrinkles, sags, or bagginess. To achieve this desirable appearance and enable lay persons to install covers easily, bollard covers conventionally have been made to match the height and shape of the bollard as closely as practical. But bollards vary widely in height, girth and shape, making it difficult to achieve a smooth, tight fit between the bollard cover and the bollard over a wide variety of bollards, without customizing the bollard cover for each variation. Such customization makes it difficult to manufacture large quantities of bollard covers before knowing the size and shape of the bollard to be covered, which in turn slows delivery times.

Therefore, it is an object of this invention to provide a bollard cover system and method for an easily-changeable bollard cover that is self-fitting over a variety of bollard shapes and sizes.

### SUMMARY OF THE INVENTION

The present invention is a system and method of covering a bollard with removeable advertising. The bollard cover comprises a fabric sock which has graphics printed on it. The fabric sock has at least one opening and has a retention mechanism near the opening to releaseably couple the fabric sock to the bollard after it is installed over it. Preferably the retention mechanism is an elastic band that expands to encircle the bollard and hold it in place. The fabric sock may have more than one opening and may have a retention mechanism near each opening. In a preferred embodiment, the fabric sock is longer than the bollard is tall and is made of a flexible material that stretches in both directions. When the fabric sock is used in combination with a plastic sleeve over the bollard, the excess sock is caught between the rigid sleeve and the bollard such that, as the sleeve and sock are pushed down over the bollard, the fabric sock is tightened over the bollard. In this way a fabric sock of a given size can fit snugly over bollards of varying other sizes and still present a smooth graphic design that looks as if it is painted on the bollard.

### BRIEF DESCRIPTION OF THE DRAWINGS

FIG. 1A illustrates a perspective view of two prior art flat-top cylindrical bollards of different dimensions.

FIG. 1B illustrates a perspective view of a bollard covered by a bollard cover in accordance with one embodiment of the present invention.

FIG. 2A illustrates a perspective view of two prior art flat-top cylindrical bollards of different dimensions.

FIG. 2B illustrates a perspective view of a bollard covered by a bollard cover in accordance with another embodiment of the present invention.

FIG. 2C illustrates the top view of the bollard cover of FIG. 2B.

FIG. 2D illustrates a perspective view of the bollard cover of FIG. 2B.

FIG. 2E illustrates the bottom view of the bollard cover of FIG. 2B.

FIG. 3A illustrates a side view of a U-shaped bollard in the prior art.

FIG. 3B illustrates a side view of a U-shaped bollard covered by a bollard cover in accordance with another embodiment of the present invention.

FIG. 3C illustrates a side view of the bollard cover of FIG. 3B.

FIG. 3D illustrates a perspective view of the bollard cover of FIG. 3B.

FIG. 4A illustrates a perspective view of a prior art drive-though ordering kiosk.

FIG. 4B illustrates a perspective view of a drive-though ordering kiosk covered by a bollard cover in accordance with another embodiment.

FIG. 4C illustrates the top view of the bollard cover of FIG. 4B.

FIG. 4D illustrates a perspective view of the bollard cover of FIG. 4B.

FIG. 5 illustrates a method for a bollard advertising program in accordance with one embodiment.

FIGS. 6A-D illustrate a perspective view of fabric socks according to a preferred embodiment of the present invention.

FIG. 6E illustrates a side view of a fabric sock collapsed on itself.

FIG. 7A-E illustrate a perspective view of a fabric sock installed over a plastic sleeve over a bollard, according to a preferred embodiment of the present invention.

FIG. 8 illustrates a cross-section view of FIG. 7E.

FIGS. 9A-B illustrate a sock having two openings installed over a bollard using a sleeve.

FIGS. 9C-D illustrate a sock having two openings installed over a bollard.

FIG. 10 illustrates a cross-section view of a sock installed over a sleeve and a bollard using fasteners.

FIG. 11A illustrates a perspective view of a sock showing a friction ring in combination with a retention mechanism.

FIGS. 11B and C illustrate a perspective view of a sock showing a friction ring without a retention mechanism.

FIGS. 12A-C illustrate top views of a portion of various friction rings.

FIG. 13A illustrates a cross-section view of a sock with a friction ring on the outside installed over a sleeve and a bollard.

FIG. 13B illustrates a cross-section view of a sock with a friction ring on the inside installed over a sleeve and a bollard.

### DETAILED DESCRIPTION

As used herein, bollards include structures used to divert traffic; posts used to support structures such as signs or fencing; drive-through speaker boxes; pillars, columns, and stanchions; concrete parking berms, and the like. Bollards may be solid or hollow. Most often they are cylindrical, but may also be spherical, pyramidal, rectangular, hexagonal, or other symmetric shape; they may even be asymmetrically shaped.

In accordance with principles of the present disclosure, the functionality and utilization of a bollard cover may be improved by applying or integrating advertising or other media to the bollard cover. For example, the exterior opaque colored face of the bollard cover may be covered with a surface applied, digitally printed, full color, pressure-sensitive vinyl (“PSV”) image, creating additional applications including but not limited to promotional advertising, public communication, corporate branding, visual displays, etc. The displays may be on or about at ground level, or much higher, depending on the need of the installation.

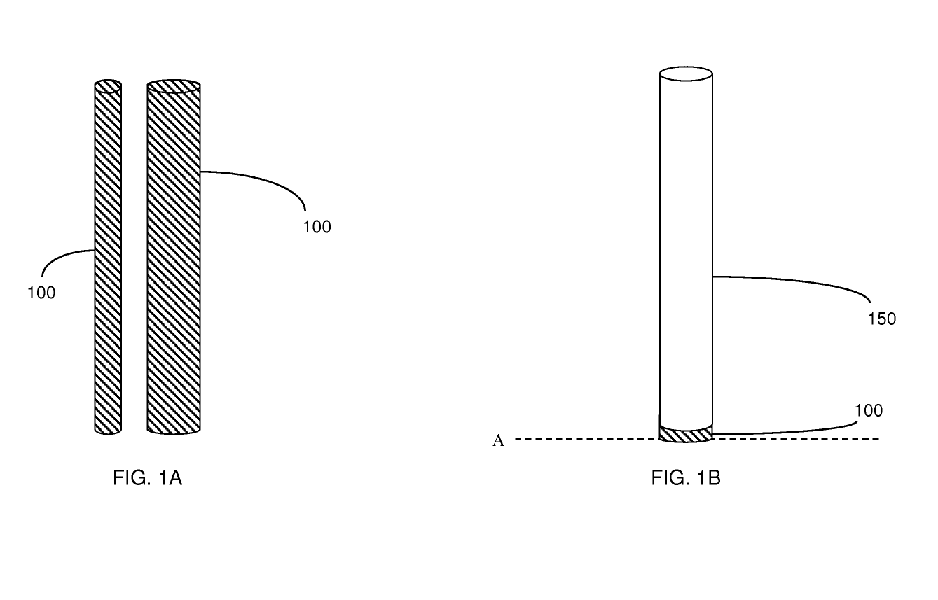

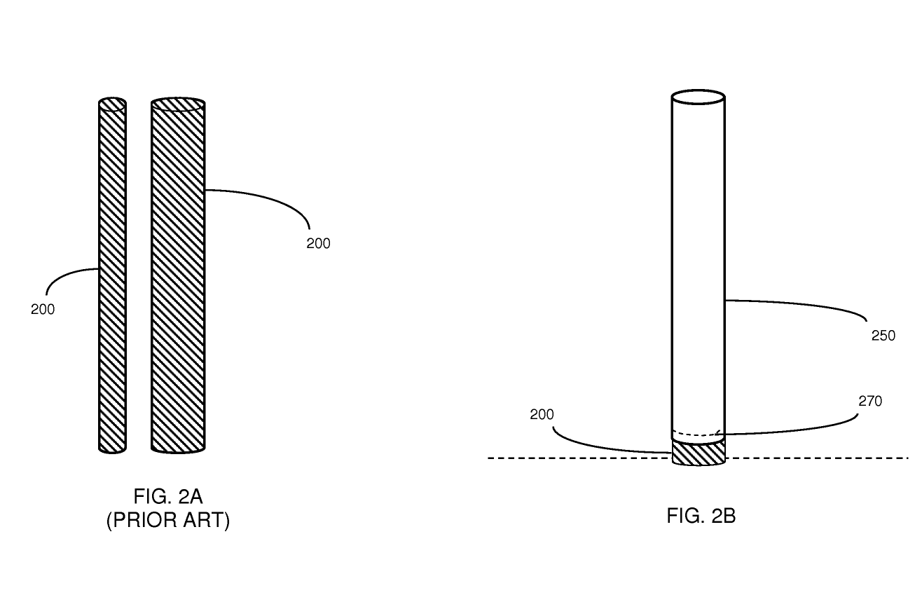

In accordance with principles of the present disclosure, in an exemplary embodiment a bollard cover 150 for advertising comprises a polyethylene plastic post sleeve in the standard opaque color and stock sizes and incorporates surface applied, digitally printed, full color PSV image using UV curable or solvent ink. See FIGS. 1B, 2B-2D, 3A-3C, and 4B. The selected ink may be UV resistant in order to withstand environmental conditions. The PSV is then surface applied and wrapped to completely or partially cover bollard cover 150 and contours thus creating a three-dimensional graphic image on bollard cover 150, such that when bollard cover 150 is coupled to a concrete post or steel pipe bollard, the graphic design achieves maximum vehicular and pedestrian exposure and additional functionality including advertising, communication and branding using a bold, refreshing new medium.

In various exemplary embodiments, bollard cover 150 may be monolithic. In other exemplary embodiments, bollard cover 150 may comprise multiple layers, for example an inner structural layer such as HDPE, a middle graphic layer such as PSV, and optionally a clear outer protective layer such as a pressure sensitive vinyl laminate. In certain embodiments, the middle graphical layer or the outer protective layer may be removeable or replaceable, for example in order to facilitate changing or updating the graphical content as desired. Moreover, bollard cover 150 may be configured to partially or completely cover a bollard 100.

Bollard cover 150 may be generally cylindrical. In some embodiments, bollard cover 150 has a flat top; in other embodiments, bollard cover 150 has a rounded or hemispherical top; in yet other embodiments bollard cover 150 is open at both ends.

Bollard covers 150 configured in accordance with principles of the present disclosure may be fabricated from any suitable durable materials, for example plastics. Moreover, images may be directly fabricated on or in bollard cover 150; alternatively, bollard cover 150 may be coupled to a graphic wrap or other suitable medium for presenting media as discussed above.

Media or advertising on bollard cover 150 may be changed from time to time, for example to feature new products or services, such as by removing bollard cover 150 from a concrete or steel bollard 100 and reapplying new graphics.

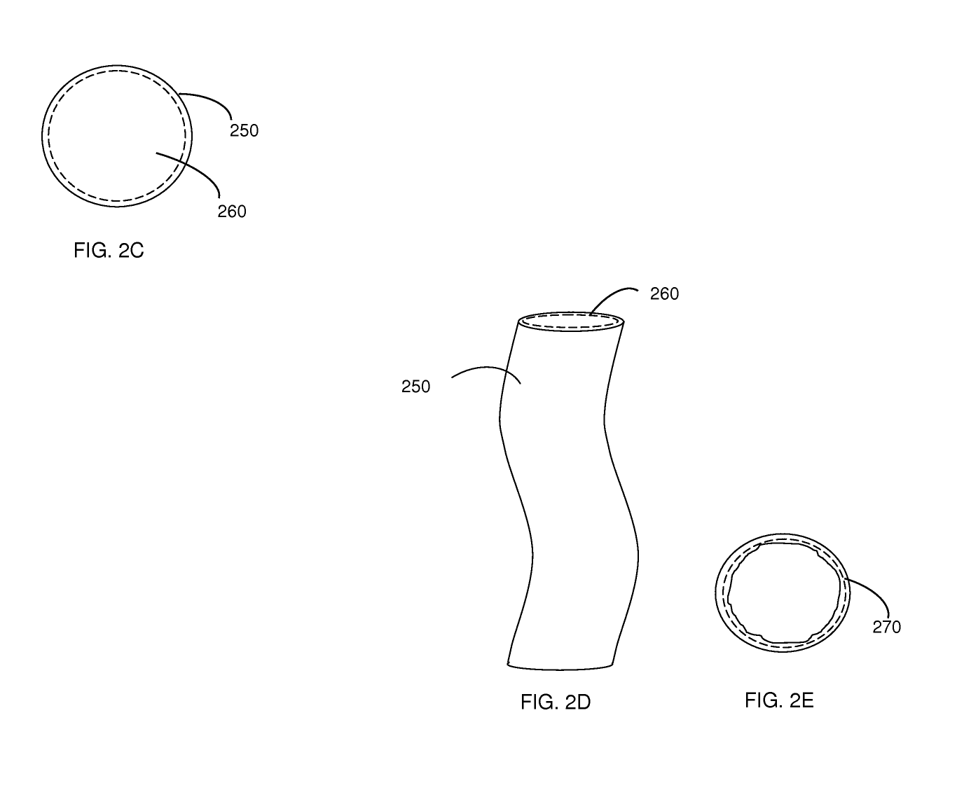

With reference now to FIGS. 2B through 2D, in certain exemplary embodiments a bollard cover 250 may be formed from a flexible or stretchable material, for example a textile. In an exemplary embodiment, a bollard cover 250 comprises a stretchable material, for example elastane, Polartec® Power Stretch fabrics, KI brand Soft Knit fabrics, a polyester textile or polyester-coated textile, or the like. Bollard cover 250 may be generally cylindrical with a flat stitched top 260; moreover, bollard cover 250 may be configured with any suitable dimensions or portions to facilitate at least partially covering a bollard 200.

Bollard cover 250 may be decorated, labeled, printed, marked, painted, stenciled, dyed or otherwise configured with advertising, marketing, media, or other information or symbols via any suitable process or method. If printed, the printing may be made by screen printing or digital printing, either by printing it directly on the textile or indirectly by dye sublimation from a paper transfer sheet. In a preferred embodiment, the graphics are digitally printed at high resolution on a paper transfer sheet and then transferred to the bollard cover 250 through a dye sublimation process.

In various exemplary embodiments, bollard cover 250 may comprise a retention mechanism 270, such as a flexible cinch or drawstring to facilitate retention on bollard 200. Retention mechanism 270 may be releasable to facilitate removal of bollard cover 250 from bollard 200. In an exemplary embodiment, retention mechanism 270 comprises a polyester drawstring of about ⅛″ thickness, and bollard cover 250 is sewn or structured to fit bollard 200. In another exemplary embodiment, retention mechanism 270 comprises an elastic band of about ¼″ thickness, and bollard cover 250 is sewn or structured to fit bollard 200. Moreover, bollard cover 250 may be releasably coupled to bollard 200 via any suitable materials, structures, or approaches.

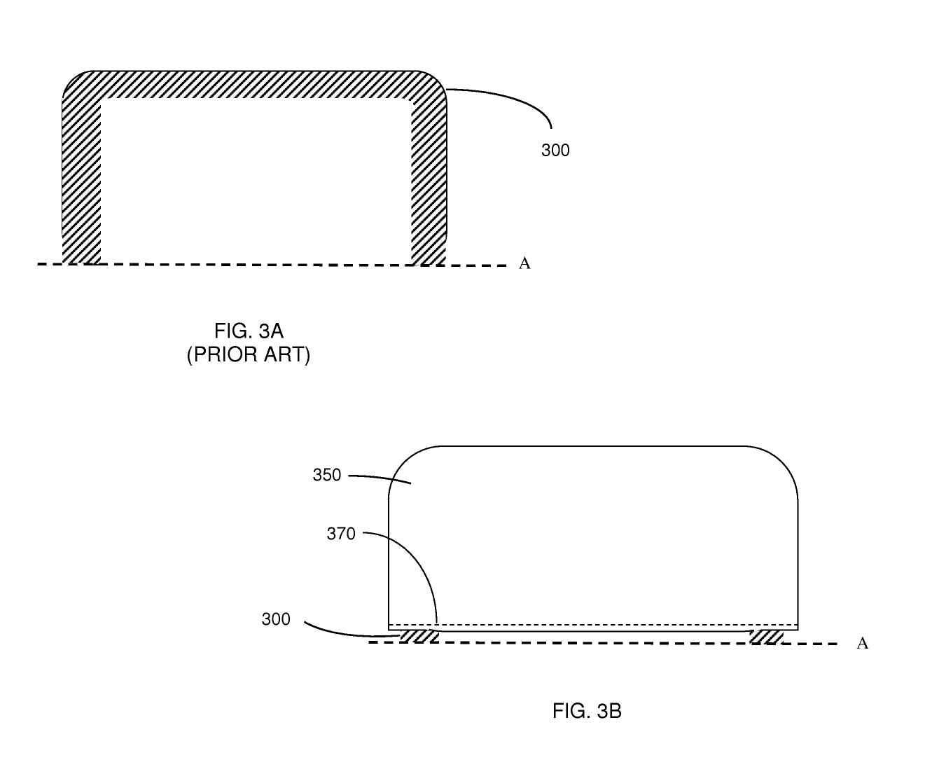

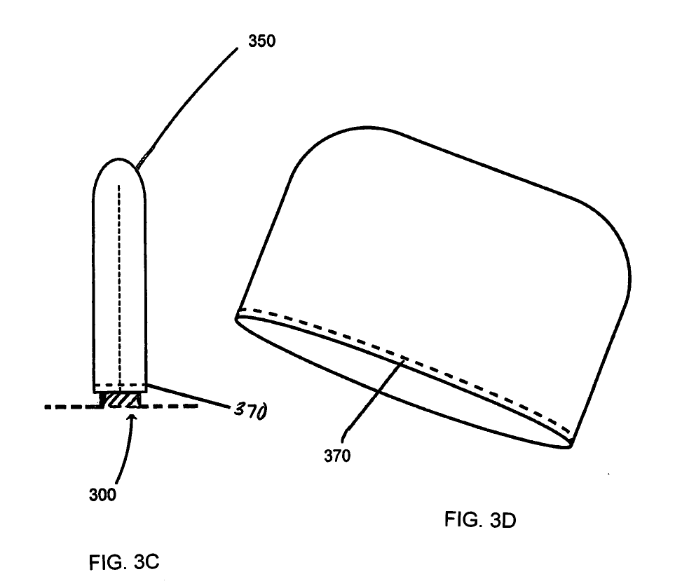

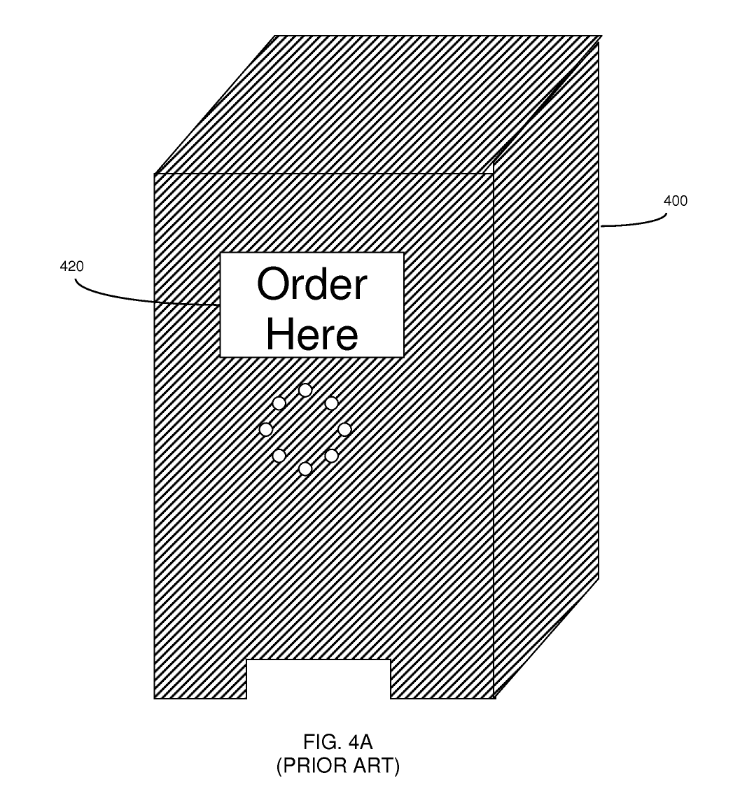

Turning now to FIGS. 3A through 3D, in accordance with principles of the present disclosure, a bollard cover may be utilized in connection with bollards or other objects that have a shape or orientation other than an upright cylinder. In various exemplary embodiments, a bollard cover 350 may be utilized in connection with a U-shaped bollard 300. Bollard cover 350 may comprise a material or materials similar to bollard cover 250 discussed herein; moreover, bollard cover 350 may be configured with a retention mechanism 370 to facilitate retention on bollard 300. Retention mechanism 370 may be configured and utilized in a manner similar to retention mechanism 270 discussed herein. Bollard cover 350 may be configured with permanent or changeable advertising, graphics, or other media as discussed herein.

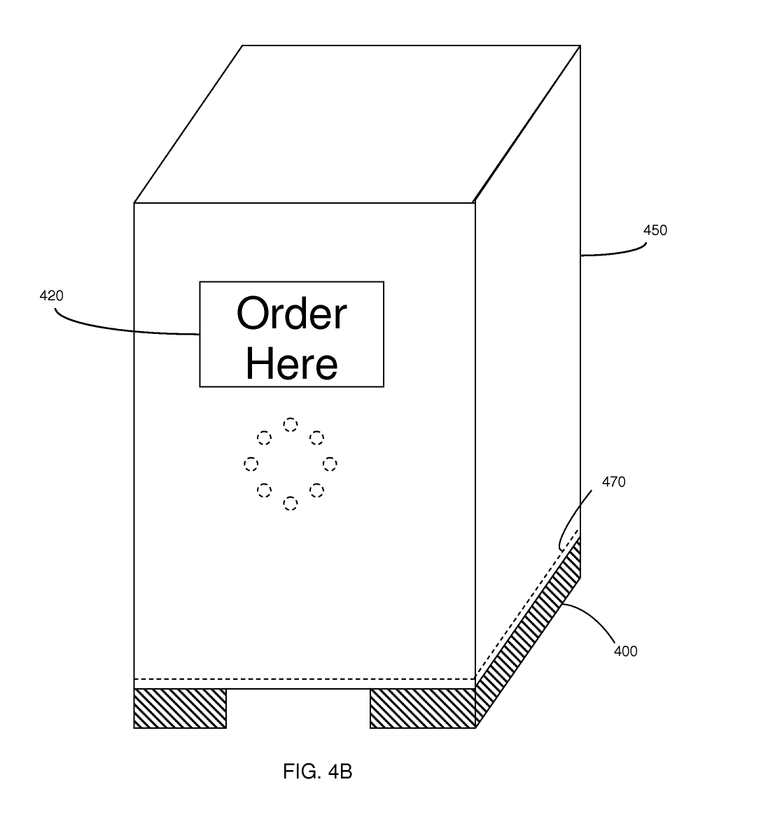

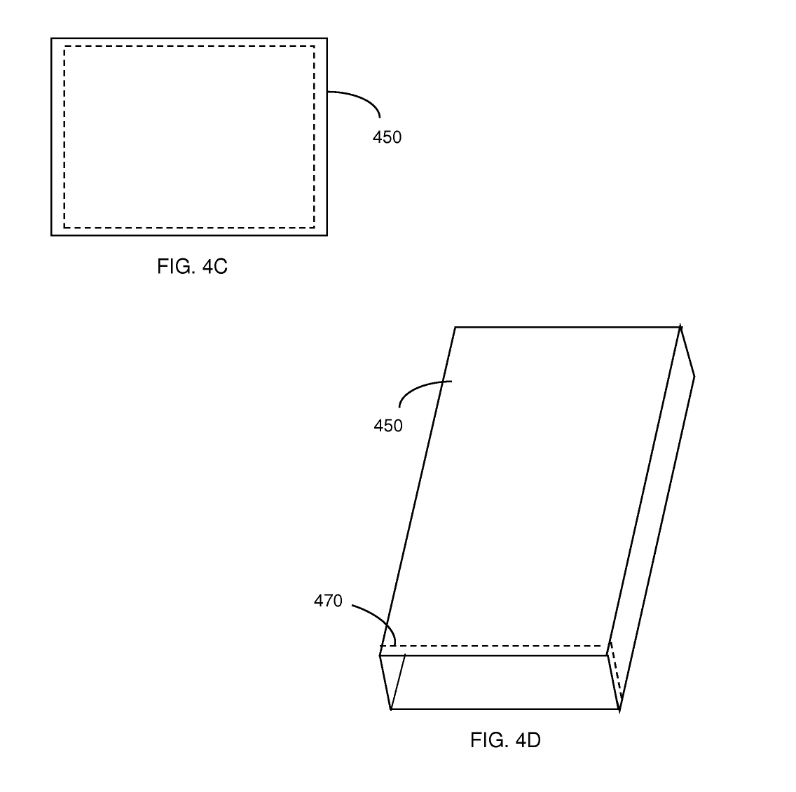

With reference now to FIGS. 4A through 4D, in accordance with principles of the present disclosure, a bollard cover may be utilized in connection with a drive-through speaker box or ordering kiosk, for example as commonly utilized at a fast-food restaurant. In certain exemplary embodiments, bollard cover 450 is configured to fit over or at least partially conceal a drive-through speaker box 400 having a screen or speaker 420. Bollard cover 450 may comprise similar materials to bollard cover 250 or 350; moreover, bollard cover 450 may be configured with an opening or aperture in order to avoid obscuring the screen or speaker 420. Bollard cover 450 may be configured with a retention mechanism 470 to facilitate retention on speaker box 400. Drawstring 470 may be configured and utilized in a manner similar to retention mechanism 270 or 370 discussed herein. Bollard cover 450 may be configured with permanent or changeable advertising, graphics, or other media as discussed herein.

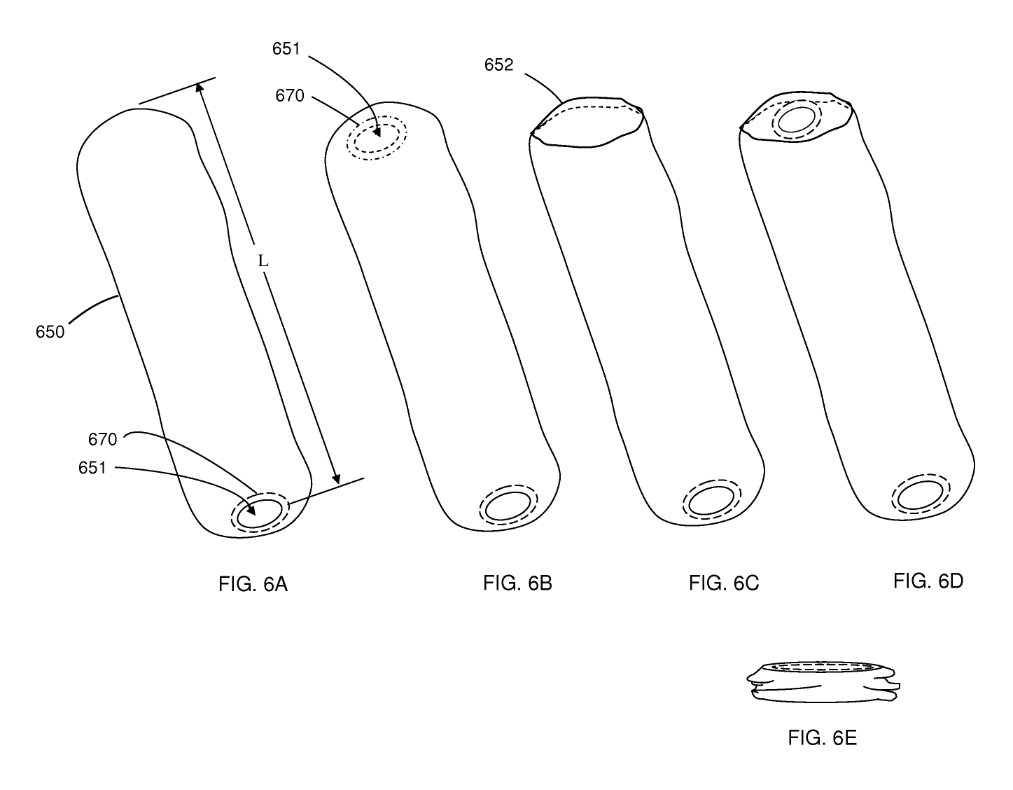

Now turning to FIGS. 6-8, a preferred embodiment is presented. In this embodiment, the bollard cover comprises a sock 650 of length L having at least one opening 651 to enable the sock to be placed over or around a bollard and anything on it. See FIGS. 6A and 6C. FIGS. 6B and 6D shows a sock 650 with a two openings 651, which is useful in situations in which the bollard cover does not need to cover the entire structure. For example, the bollard cover shown in FIG. 6B could be placed over a sign post, in which the sign shows above the top opening and only the post itself is covered by the sock.

The sock 650 may comprise a retention mechanism 670, such as a cinch or drawstring, near one or more of the openings to facilitate retaining the sock 650 on a bollard 600. In a preferred embodiment, the retention mechanism is elastic, capable of expanding enough to allow the fabric sock 650 to be placed over or around the bollard and any anything on it, and capable of contracting back to the desired size necessary to keep the sock 650 on the bollard. In another embodiment, the retention mechanism 670 on the top end of the sock 650 can be sufficiently contracted around the bollard to support the weight of the sock, such that the sock retains a smooth surface when hanging from the retention mechanism 670. Retention mechanism 670 may be releasable or severable to facilitate removal of the fabric sock 650 from bollard 600.

The sock of the preferred embodiment is made of a flexible fabric that stretches in at least two directions to accommodate bollards of various sizes and shapes. The fabric is sufficiently stretchy when it is capable of expanding enough to allow the sock 650 to be placed over or around the bollard and any anything on it, and capable of contracting back to the desired size necessary to present a smooth graphics display one the sock 650 is on the bollard. Due to its stretch, the sock's dimensions when it is at rest may be smaller than the bollard it is intending to cover. Once installed, a tight fit around the entire bollard is preferred, but not necessary. While it is preferable that the sock approximates the general shape of the bollard, socks may be made of fabric that is sufficiently stretchy to accommodate bollards that are not the same general shape as the sock. For example, if the bollard is rectangular, a cylindrical fabric sock of sufficiently stretchy fabric may be used to cover it and still achieve a smooth graphical appearance. Sock fabric may be knit or woven. If the fabric is woven, it may be woven flat or in tubes. Making a sock out of flat weave fabric results in a seam where the ends of the fabric meet, as shown in FIG. 1B.

In a preferred embodiment, the fabric is so flexible as to be collapsible on itself, much like a traditional sock for a human foot. FIG. 6E illustrates a side view of a fabric sock of the present invention collapsed on itself. For clarity FIG. 6 shows the sewn-in top disposed parallel to the ground as if the top retains its form when the sock is collapsed. However, the top may collapse on itself too, so that, in essence, the collapsed sock is a wad of printed fabric. With such flexibility, fabric socks can be easily shipped in much smaller packages than less flexible bollard covers, thereby reducing shipping costs and making it convenient to keep spare socks on hand.

In a preferred embodiment, graphics are printed on the sock 650 by digitally printing the desired image at high resolution on a paper transfer sheet and then transferring the image to the sock 650 through a dye sublimation process. The density of the image is preferably sufficient that when the sock 650 is stretched to cover the bollard, the image remains its desired resolution. Preferably the density of the images is 72-150 dots per inch.

In some embodiments the sock 650 is of the same general shape of the bollard. For example, the socks 650 shown in FIGS. 6A-D are cylindrical for covering cylindrical bollards such as those shown in FIGS. 1A and 2A. The socks 650 can be more tailored to a cylindrical bollard with a flat top by sewing a flat top 652 into the end of the sock, as shown in FIGS. 6C and 6D. Alternatively, if the bollard has a rounded top, a round top can be sewn into the end of the sock. In both cases, the socks are made of flexible, stretchable fabric. Due to the stretchiness of the fabric, preferably the sock is applied directly to the bollard or sleeve, as described below, without intervening foam support pads. The sock may contract so tightly over such supports that it takes on the shape of the supports, which may not be as smooth as desired.

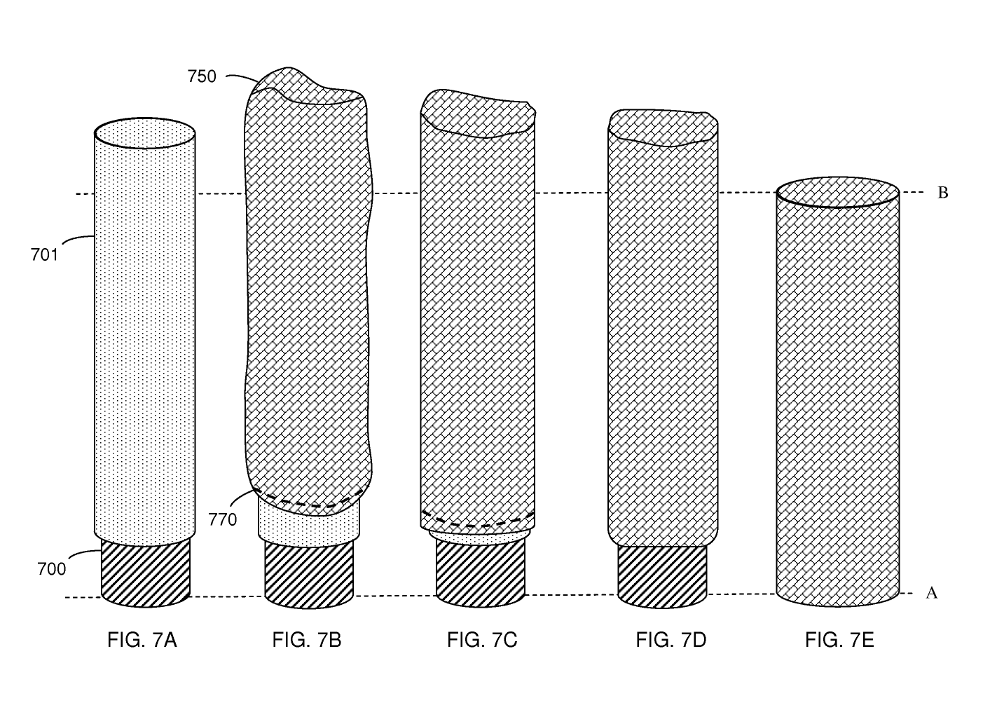

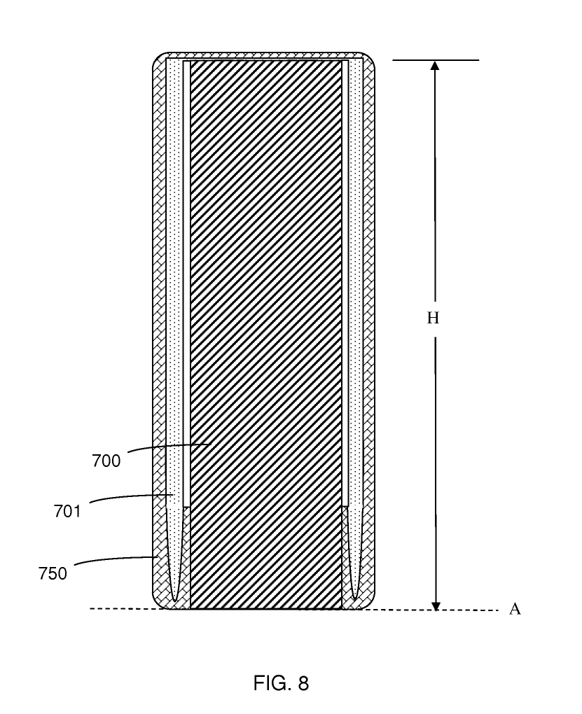

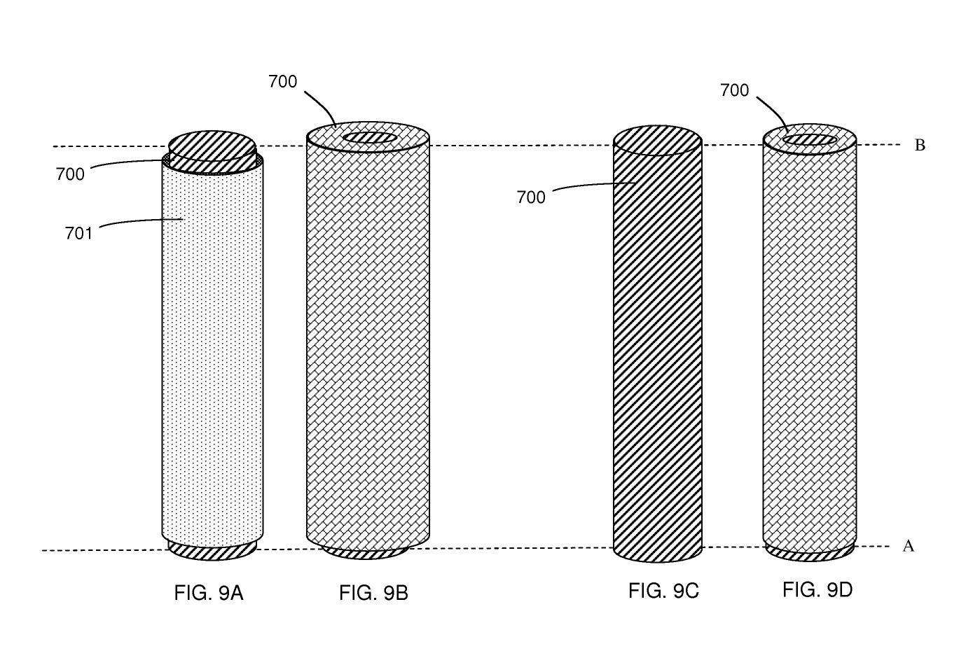

In another preferred embodiment, the sock 750 is used in combination with a bollard sleeve, typically plastic as known in the art, that is more rigid than the sock. The sleeve may be deformable but is not stretchy. See FIGS. 7A-7E, which illustrate covering a cylindrical bollard 700 having a closed flat top. In other embodiments, the sleeve may have an open top, or a closed top that has rounded edges connecting the side and top, or a hemispherical top. The sleeve 701 may be placed partially over the bollard, as shown in FIG. 7A. The sock 750 is placed over the sleeve 701, as shown in FIG. 7B. The sock 750 is tugged down over the sleeve 701 and the end 751 of the sock is tucked under the end of the sleeve 701 so that the sock 750 is sandwiched between the sleeve 701 and the bollard 700. The now-paired sock 750 and sleeve 701 are guided over the bollard 700 until the paired sock-sleeve cover the bollard. See FIGS. 7C-7E. Sandwiching the sock 750 between the sleeve 701 and the bollard 700 causes the sock 750 to be pulled taught over the sleeve 701, smoothing the face of the sock on the sides and top of the sleeve, and providing a smooth display. See FIG. 8. Preferably the sock-sleeve pair rests on the ground, indicated by dotted line A, with the top of the bollard indicated by dotted line B. However, in some cases the sock-sleeve pair may be shorter than the bollard and rest above the ground. Optionally, as shown in FIGS. 7B -7C, the sock 750 may have a retention mechanism 770, which may help hold the sock 750 in place during and after installation. The sleeve 701 may be re-used with a new sock 750 whenever the old sock 750 is changed.

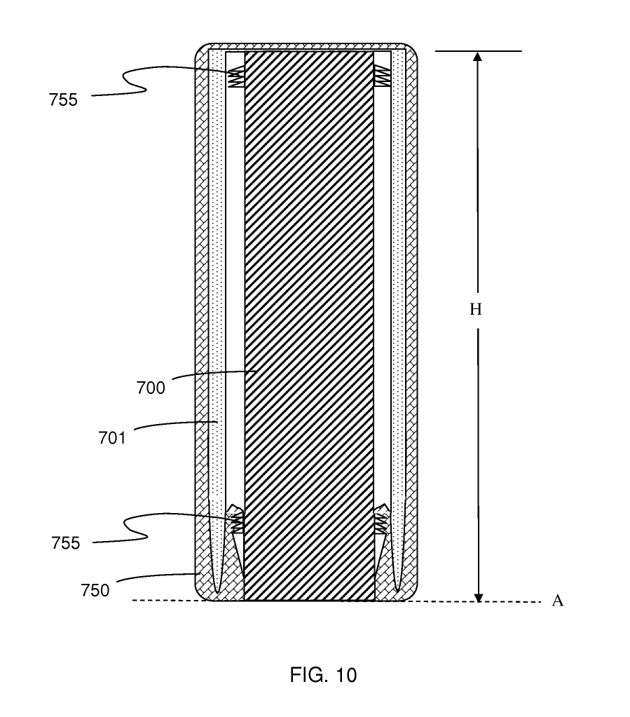

In some embodiments the sleeve may fit closely to the bollard, and in others it may be significantly bigger in one or more dimensions than the bollard. In cases in which the sleeve 701 is bigger than the bollard 700, it may be useful to use a fastener 755 between the sleeve and bollard to hold the sock in place over the sleeve by narrowing the space between the sleeve and bollard, so that it can be stretched tight. FIG. 10 shows a fastener 655 comprising a ribbed device that is inserted between the sleeve 701 and the bollard 700. In some embodiments the fastener is attached to the bollard, for example by adhesive. After the sock is tucked between the sleeve and the bollard, the fabric catches on the ribs of the fastener, which hold the sock in place. The same fastener may also be used to act as a spacer to keep a large sleeve a constant distance from the bollard.

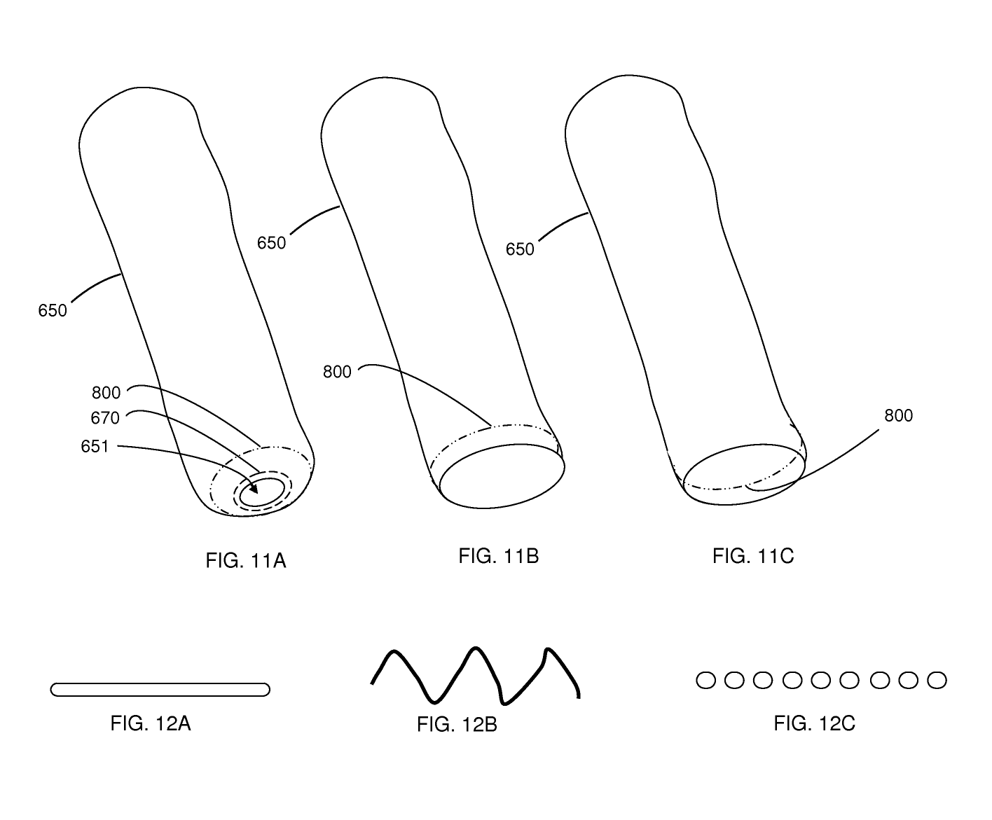

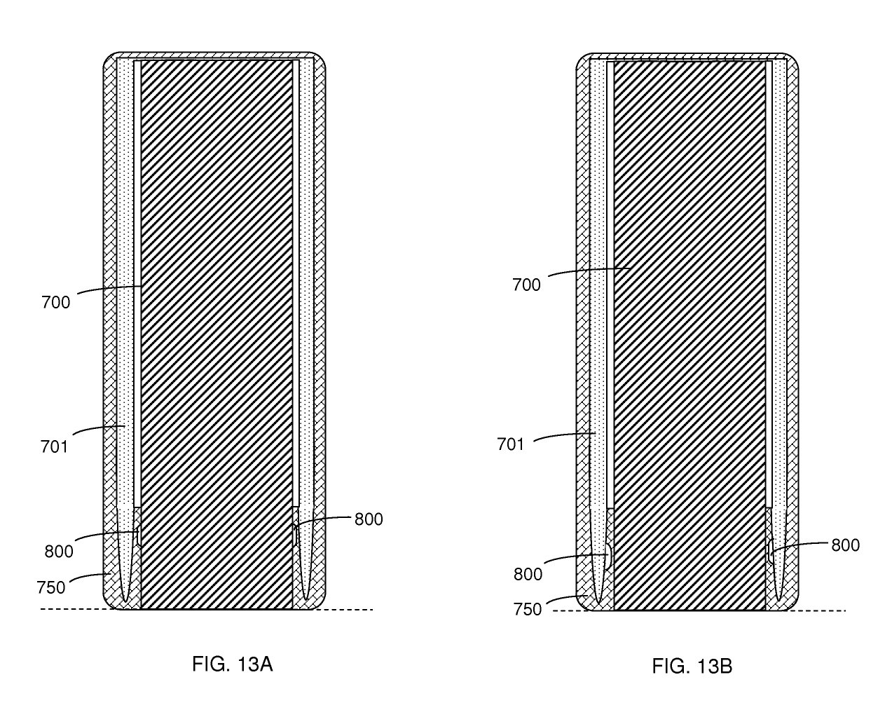

In another embodiment the sock 750 utilizes a friction ring 800 at one end, in lieu of or in combination with retention mechanism 670 or fastener 655, to snug the sock 750 to the bollard 700. The friction ring helps secure the sock between the sleeve 701 and the bollard 700, as shown in FIGS. 7A-E, so that it can be stretched tight. FIG. 11A illustrates a sock 750 with a friction ring 800 in combination with a retention mechanism 670. FIG. 11B illustrates a sock 750 with a friction ring 800 alone on the outside of the sock 750; FIG. 11C illustrates a sock 750 with a friction ring 800 alone on the inside of the sock 750. The friction ring 800 is preferably on the outside of the sock 750, so that when the sock 750 is tucked under the sleeve 701 the friction ring 800 engages the bollard 700. FIG. 13A illustrates a sock with a friction ring on the outside of the sock surface installed over a sleeve and a bollard. Optionally the friction ring 800 may be on the inside of the sock 750, so that when the sock 750 is tucked under the sleeve 701 the friction ring 800 engages the sleeve 701. FIG. 13B illustrates a cross-section view of a sock with a friction ring on the inside installed over a sleeve and a bollard. The friction ring 800 can be made of any substance that increases the friction between the sock 750 and the sleeve or bollard, such as adhesive, rubber, silicone, plastic, vinyl or fabric. The friction ring 800 can be one continuous piece, as shown in FIGS. 12A and B, or a series of beads as shown in FIG. 12C. FIG. 13B illustrates a cross-section view of a sock with a friction ring on the inside surface installed over a sleeve and a bollard.

Preferably the length L of the sock 750 is greater than the height H of the sleeve, in which case the excess sock is tucked between the sleeve 701 and bollard 700, thus reducing the effective size of the sock 750. The length L of the sock 750 may range from 0 to 300% of height H, and is limited only by how much of the excess can be tucked between the sleeve and bollard to achieve the smooth surface. However, in some cases the length L of the sock 750 is the same or shorter than the height H of the sleeve, in which case the sock is stretched in its lengthwise direction enough to be longer than the sleeve 701, and that excess that is tucked between the sleeve 701 and bollard 700.

The stretchable fabric and retention mechanism cooperate to make the sock easy to place, remove, and change for inexperienced and experienced people alike. Fabric socks can be easily stored in much smaller volumes than traditional rigid bollard covers, making it convenient to keep spare socks on hand. The result is that bollard covers and can be changed by the employees who work at the businesses where the bollards are present, as opposed to requiring a service call from an experienced graphics or sign company. Damaged socks that are unsightly are quickly changed to fresh-looking new socks. New advertising campaigns are easily and quickly updated by the businesses.

In certain exemplary embodiments, a plurality of bollard covers (for example, bollard covers 150, 250, or 350, and socks 650 or 750) may be disposed over bollards that are located close to one another. Each of the bollard covers may be configured with a portion of graphical content, such that a single overall image may appear to be distributed across multiple bollard covers. In other exemplary embodiments, a plurality of bollard covers may be placed over a series of bollards in a cascading fashion, such that when a pedestrian passes by the series of bollards, the pedestrian is exposed to a sequential message or other marketing content distributed across the bollard covers.

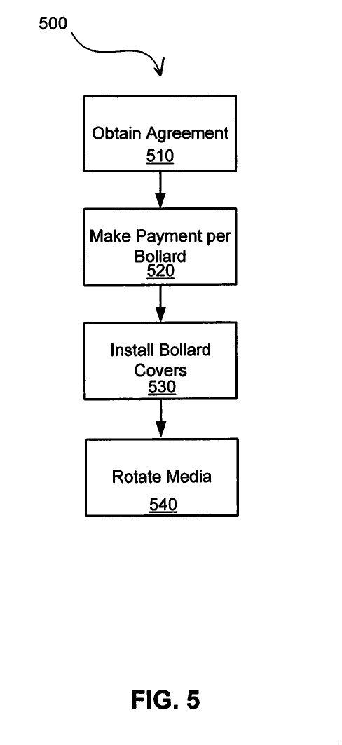

In various exemplary embodiments, with reference now to FIG. 5, a bollard advertising program (“BAP”) utilizing bollard covers configured in accordance with principles of the present disclosure allows an expanded medium for advertising agencies and business owners. An exemplary BAP 500 targeted at convenience stores or gas stations may include (i) obtaining lease agreements (for example, about 1 year to about 5 year agreements) for the bollard areas (step 510), and (ii) paying the convenience store or gas station an amount of money on a quantity basis to use the bollard space (step 520), creating a no-cost immediate revenue source for the business. Bollard covers configured with advertising or other media are installed on the bollard (step 530). The advertising on the bollards may be rotated (step 540), for example on a scheduled basis, according to the requests of a national brand, according to the requests of the convenience store, and so forth.

Bollard covers and BAPs may be utilized for various industries or locations, for example universities, hospitals, fast-food locations drive through lanes, chains, convenience stores, gas stations, parking structures, concert or event venues, check cashing, sports arenas, movie theaters, automotive service companies, utility companies, banks, pharmacies, entrances to retail store fronts, inside retail locations, traffic way finding, or the like.

By utilizing bollard covers configured in accordance with principles of the present disclosure, an improved means to advertise and communicate with retail, institutional and industrial customers is achieved. By utilizing bollard covers configured in accordance with principles of the present disclosure, underutilized space in business parking and pedestrian areas may be captured, enhanced, and leveraged into eye-catching, appealing branding or advertising locations. Additionally, bollard covers configured in accordance with principles of the present disclosure provide protection to vehicles from the hard concrete post or the steel pipe surfaces by reducing vehicle scratches and dents due to accidental contact.

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A bollard cover for a bollard comprising:
a sock covering the bollard, the sock comprising a flexible, stretchable fabric, the sock having graphics printed thereon;
the sock having a first end and a second end, wherein at least one of the first end and the second end comprises an opening to receive the bollard.

2. The bollard cover of claim 1 wherein the fabric is so flexible as to be able to allow the sock to collapse onto itself.

3. The bollard cover of claim 1 further comprising a retention mechanism near the first end to releaseably couple the sock to the bollard.

4. The bollard cover of claim 1 further comprising friction ring near the first end that engages the bollard.

5. The bollard cover of claim 1 wherein the bollard is a cylinder and the first end of the fabric sock is closed, the closure being a flat top sewn onto the fabric sock such that the top is immediately adjacent the bollard when the fabric sock is placed over the bollard.

6. A bollard cover for a bollard wherein the bollard is a cylinder having a height H, the bollard cover comprising:
a cylindrical fabric sock having a length L, the fabric sock having graphics printed thereon;
wherein L is greater than H and the difference between L and H is excess;
such that when the fabric sock is used in combination with a rigid sleeve over the bollard, the excess is tucked between the rigid sleeve and the bollard and tightens the fabric sock over the bollard.

7. The bollard cover of claim 6 wherein L is greater than H by at least 2.0% of H.

8. The bollard cover of claim 6 wherein L is greater than H by up to 300% of H.

9. The bollard cover of claim 6 wherein the fabric sock has a first end and a second end, wherein at least one of the first end and the second end comprises a retention mechanism to releaseably couple the fabric sock to the bollard.

10. The bollard cover of claim 6 further comprising a fastener disposed between the sleeve and the bollard.

11. The bollard cover of claim 6 wherein the fabric is so flexible as to be able to allow the sock to collapse onto itself.

12. A bollard cover system for a bollard in the shape of an upright cylinder having a top, the bollard cover comprising:
a first sock of length L in the shape of a cylinder, the first sock comprising fabric having graphics printed thereon;
the first sock having a first end and a second end, wherein the first end comprises an opening and an elastic retention mechanism; and
wherein the first sock is used in combination with a plastic sleeve of height H having openings at both ends, wherein H is less than L, such that as the first sock is placed over the sleeve and the first sock and sleeve are together placed over the bollard, the first end is tucked between the sleeve and the bollard causing the first sock to be tight over the sleeve and the second end to be tight over the top of the bollard, such that the graphics are displayed as a smooth surface.

13. The bollard cover system of claim 12 wherein L is greater than H by at least 2.0% of H.

14. The bollard cover system of claim 12 wherein L is greater than H by up to 300% of H

15. The bollard cover system of claim 12 further comprising a flat top sewn into the second end of the first sock.

16. The bollard cover system of claim 12 further comprising a fastener disposed between the sleeve and the bollard.

17. The bollard cover system of claim 12 wherein the fabric is stretchable and so flexible as to be able to collapse onto itself.

18. The bollard cover system of claim 12 further comprising a second sock of length L in the shape of a cylinder, the second sock comprising fabric having graphics printed thereon;
the second sock having a first end and a second end, wherein the first end comprises an opening and an elastic retention mechanism; and
wherein the second sock is used in combination with the plastic sleeve, such that when the first sock is removed, the second sock is placed over the sleeve and the second sock and sleeve are together placed over the bollard, the first end of the second sock is tucked between the sleeve and the bollard causing the second sock to be tight over the sleeve and the second end of the second sock to be tight over the top of the bollard, such that the graphics are displayed as a smooth surface.

19. The bollard cover system of claim 12 further comprising a friction ring between the sock and the bollard.

20. The bollard cover system of claim 128 further comprising a friction ring between the sock and the plastic sleeve.
